(19) United States
(12) Patent Application Publication
(10) Pub. No.: US 2003/0055872 A1
(43) Pub. Date: Mar. 20, 2003

(54) System and method for enabling a secure e-commerce server

(75) Inventors: Abraham Meidan, Tel Aviv (IL); Zbeida Oren, Givataim (IL)

Correspondence Address: DR. MARK FRIEDMAN LTD., c/o BILL POLKINGHORN - DISCOVERY DISPATCH, 9003 FLORIN WAY, UPPER MALBORO, MD, 20772, US

(73) Assignee: WIZSOFT LTD.

(21) Appl. No.: 09/920,956

(22) Filed: Aug. 3, 2001

(51) Int. Cl. G06F 15/16

(52) U.S. Cl. 709/203; 709/229

(57) ABSTRACT

A mechanism for ensuring secure e-commerce transactions, which includes the process of writing a limited server that can only perform those actions that are required. This server may optionally be a single function server, enabled to implement one or more commands only. Alternative actions are simply not coded into the program. In this way the server is intentionally limited, in that it is programmed to handle the limited set of commands that are relevant for the specific field in which it operates.

### BACKGROUND OF THE INVENTION

1. Field of the Invention

The present invention relates to a system and method for enabling secure network based transactions, in order to secure transactions and data flow in the online commerce environment.

2. Description of the Related Art

Computers offer access to huge quantities of potentially valuable information. However, especially with the popularization of networks, such as the Internet, Intranets, LANs and WANs, this information is often vulnerable to access and abuse from intruders.

One of the major challenges for penetration of electronic commerce (e-commerce) has been the various security hazards. These hazards potentially open up sensitive personal and financial information to intruders, who may subsequently use the information for unauthorized purposes.

Online commerce is generally executed through servers, which are computers in a network configured to execute specific functions. Examples of network-based servers are application server, audio server, database server, fax server, file server, intranet server, mail server, merchant server, modem server, network access server, print server, proxy server, remote access server, telephony server, terminal server, video server and Web server. There are currently many Web, or Internet, servers on the market. Most of them support many functions such as CGI programs execution, FTP protocol and so on. The security problem with such servers is that they are written to execute various functions, or entertain various protocols. These servers, however, often create holes for hackers, who may use these alternative functions as back doors to enter a server computer in an unauthorized fashion.

Most servers allow the user to block some of the functions. The fact, however, that this software enables various functions in principle, opens up potential holes wherein an intruder can enter. In addition, the existing software permits the one who configures the server to incorrectly configure such a server, or forget to limit the necessary functions, etc. all of which add to its vulnerability. For this reason, therefore, most current servers are not safe, because a hacker might find a way to bypass the security mechanisms or find a back door.

There is thus a widely recognized need for, and it would be highly advantageous to have, a server that is able to execute its functions without enabling a hacker to enter the server computer or execute unauthorized actions.

### SUMMARY OF THE INVENTION

According to the present invention there is provided a mechanism for ensuring secure e-commerce transactions. This mechanism includes the process of writing a limited server that can only perform those specific actions that are required. Alternative actions are simply not coded into the program.

In this way it is impossible for a hacker to user the server for performing illegal operations, since the server does not know how to perform these actions.

### BRIEF DESCRIPTION OF THE DRAWINGS

The invention is herein described, by way of example only, with reference to the accompanying drawings, wherein:

FIG. 1 is an illustration of the system components according to the present invention.

FIG. 2 describes the method by which the present invention operates.

### DESCRIPTION OF THE PREFERRED EMBODIMENT

The present invention relates to a mechanism for securing e-commerce transactions.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention includes the process of writing a limited e-commerce server that can only perform those actions that are required. Alternative actions are simply not coded into the program, and so cannot be commanded by any users, authentic or unauthentic.

The principles and operation of a system and a method according to the present invention may be better understood with reference to the drawings and the accompanying description, it being understood that these drawings are given for illustrative purposes only and are not meant to be limitinng, wherein:

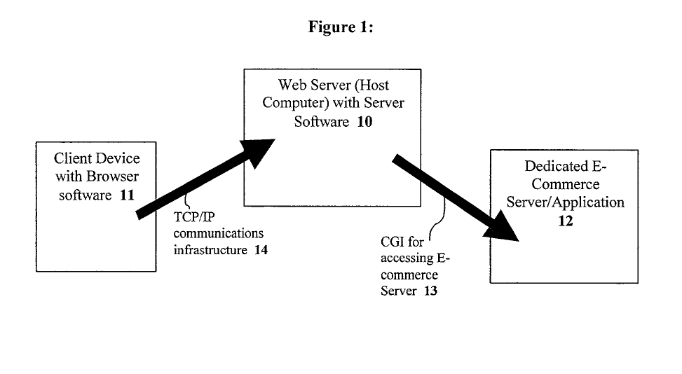

As can be seen in FIG. 1, the components of the present invention are:

10—A Web server that processes and serves user requests in a network (such as the Internet). This server 10 will generally host data such as a Web page/site, for serving to a client computer 11. This client computer 11 includes any computing or communications device that can be used to access an IP network, such as a PC, notebook, wearable computer, cellular phone, smart phone, PDA, communications gadget, car computer and appliance computer.

12—A special function server, referred to hereinafter as a “specific-function server” (which includes a dedicated E-commerce transactions server or other dedicated application server), which is enabled to execute a limited set of actions only, such as process transaction requests originating from the Web server 10.

13—A program (such as a Common Gateway Interface (CGI), Java and JavaScript program and/or ActiveX component), for transferring requests from the Web server 10 to the E-commerce (specific-function) Server 12. Such a mechanism is used to make Web sites interact with databases and other programs.

14—A network, featuring a TCP/IP communications infrastructure, which connects a plurality of client computers to the Web server, for the purpose of transferring information between the host server and the client computers.

The specific-function server 12 component includes server software that is written to be operative for specialty functions only, such as processing shopping cart data for e-commerce transactions. In this way the specific-function server 12 (which optionally be a single or specific-function server) is inherently limited, in that it is programmed to handle the limited set of commands that are relevant for the specific field in which it operates. In the shopping cart example mentioned above, the server may enable adding items to the cart, access user shopping history etc. The specific-function server 12 deals with these functions, by using specialized commands in order to execute the desired request, if compatible with the server. If the request is incompatible, or unknown to the specific-function server 12, such as reporting credit card numbers used, or some other unspecified task, the request will be denied or ignored.

On the other hand, the specific-function server 12 cannot enable alternative activities, such as downloading files, reading files found in other directories on the computer/server. All other actions are simply not programmed into the specific-function server 12, so that the specific-function server 12 does not know how to perform these other actions. In this way, it is impossible for a hacker to user the server for performing un-authorized operations, such as stealing alternative information or accessing secret files. For example, the writer of a specific-function server 12 according to the present invention writes code to run specific commands only. It is therefore not required to encode the specific-function server 12 to ignore or reject alternative functions, as these alternative functions are simply not part of the specific-function server 12 architecture, and cannot be run or processed, by definition. It is important to emphasize that the denial to carry out the alternative command is not be because of a discovered security breach, but due to an intrinsic inability of the system to implement the command.

Another example of the application of the present invention is in the case where a server is designed to execute a certain CGI program 13, and retrieve files from a certain directory on the disk. CGI (Common Gateway Interface) is a standard that specifies how programs run from a World Wide Web server. The CGI specification defines how arguments are passed and how programs are executed. A typical CGI program returns an HTML page formatted in a manner completely dependent on the user's request. In the current example, the specific-function server 12 is programmed to do only the limited function of running a particular CGI program 13 and retrieving files from a certain directory on the disk. Consequently, other CGI programs or FTP files are not available in any way to any external source.

Likewise, the specific-function server 12 may be designed to process only particular Active Server Pages or Java Server Pages (using ActiveX components, Java and JavaScript programs).

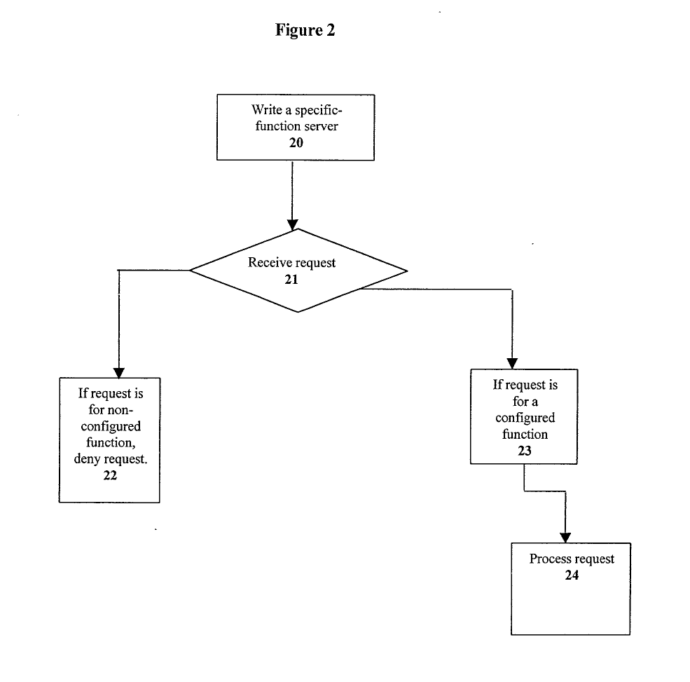

The process according to the present invention can be seen with reference to FIG. 2. As can be seen, a specific function server 12 is written 20, and is connected to a generic server in a network. A request is subsequently received 21 by the specific function server 12. If the request is for a non-programmed function, the request is denied 22. If the request is for a configured function 23, the request is processed 24.

### Advantages of the Invention

The present invention enables the simple and efficient configuration of a highly secure e-commerce system. This configuration, as contrasted to currently known e-commerce platforms, has improved security features, and is substantially simpler to setup and operate.

The present invention provides a means for configuring single-function servers that are capable of providing highly dedicated, efficient and secure services.

### Alternate Embodiments

Several other embodiments are contemplated by the inventors. For example, an embodiment wherein the specific-function server is written to execute any specific number of functions, such as two, three or a particular number of functions. Such as server is written according to the specific requirements, such that only those requests which are initially encoded can be processed.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A mechanism for enabling secure information transfer in a network, comprising:
i. a server for processing and serving user requests in a network; and
ii. a dedicated server component for processing and serving user requests from said server, such that said dedicated server is a special-function server.

2. The mechanism of claim 1, further comprising a program for transferring requests from said server to said dedicated Server.

3. The mechanism of claim 1, further comprising a network, for connecting a plurality of client computers to said server, for the purpose of transferring data between said server and said client computers in said network.

4. The mechanism of claim 1, wherein said special-function server is a single-function server.

5. The mechanism of claim 4, wherein said single-function server is an e-commerce transaction server.

6. A method for securing e-commerce transactions, comprising:
i. writing a server to execute at least one specific function;
ii. processing at least one request for said at least one specific function;
iii. in the case where said at least one request is for at least one alternative function, denying said at least one request.

7. A method for securing e-commerce transactions, comprising:
i. writing a server for processing at least one specific e-commerce transaction;
ii. processing at least one request for at least one specific e-commerce transaction;
iii. in the case where said at least one request is for at least one alternative function, denying said request.
